(19) United States
(12) Patent Application Publication
(10) Pub. No.: US 2018/0082386 A1
(43) Pub. Date: Mar. 22, 2018

(54) TRAVEL ADVISOR FOR VISITING DIFFERENT COUNTRIES

(71) Applicant: International Business Machines Corporation, Armonk, NY (US)

(72) Inventors: Gregg M. Arquero, Poughkeepsie, NY (US); Eli M. Dow, Wappingers Falls, NY (US); Syed F. Hossain, Hopewell Junction, NY (US); Joshua Schaeffer, White Plains, NY (US); Yunli Tang, Poughkeepsie, NY (US)

(21) Appl. No.: 15/269,074

(22) Filed: Sep. 19, 2016

(51) Int. Cl. G06Q 50/14; G06Q 10/02

(52) U.S. Cl. CPC G06Q 50/14; G06Q 10/025

(57) ABSTRACT

Techniques for providing individualized risk assessments are provided. A computer-implemented method for providing individualized risk assessments can include receiving, by a processor, event data for a user, the event data comprising one or more event characteristics; obtaining, by the processor, a user profile comprising one or more personal characteristics of the user; obtaining, by the processor from at least one database containing risk elements, a subset of risk elements relevant to the event characteristics and the personal characteristics; and generating, by the processor, a report based on the subset of risk elements.

### BACKGROUND

The present invention relates in general to travel and activity planning. More specifically, the present invention relates to an automated advisor system and computer-implemented method for providing individualized risk assessments.

People consider various risk factors when planning to travel, especially when traveling overseas or to a different country (e.g., on vacations or business trips). For example, travel, health, and safety concerns for a particular destination can be researched and considered prior to a trip commencing. Risks associated with a particular activity are similarly considered prior to deciding whether to engage in the activity. In some cases, consideration of these risks results in significant changes to an itinerary. In the post Internet era, a huge volume of information is available for consideration. Consequently, appropriate review of all the various risks involved with a particular travel destination or activity can require painstaking collection, filtering, and review of information from a wide range of sources (e.g., local and national news reports, health warnings, travel advisories, etc.).

### SUMMARY

According to embodiments of the present invention, a computer-implemented method for providing individualized risk assessments is provided. The computer-implemented method can include receiving, by a processor, event data for a user, the event data comprising one or more event characteristics; obtaining, by the processor, a user profile comprising one or more personal characteristics of the user; obtaining, by the processor from at least one database containing risk elements, a subset of risk elements relevant to the event characteristics and the personal characteristics; and generating, by the processor, a report based on the subset of risk elements.

According to embodiments of the present invention, a system for providing individualized risk assessments is provided. The system can include a memory having computer readable instructions and a processing device for executing the computer readable instructions. The computer readable instructions that cause the processing device to: receive event data for a user, the event data comprising one or more event characteristics; obtain a user profile comprising one or more personal characteristics of the user; obtain subset of risk elements relevant to the event characteristics and the personal characteristics; and generate a report based on the subset of risk elements.

According to embodiments of the present invention, a computer program product for providing individualized risk assessments is provided. The computer program product can include a computer readable storage medium having program instructions embodied therewith, the program instructions executable by a processing device to cause the processing device to perform a method. The method can include receiving event data for a user, the event data comprising one or more event characteristics; obtaining a user profile comprising one or more personal characteristics of the user; obtaining a subset of risk elements relevant to the event characteristics and the personal characteristics; and generating a report based on the subset of risk elements.

### BRIEF DESCRIPTION OF THE DRAWINGS

The subject matter of the present invention is particularly pointed out and distinctly defined in the claims at the conclusion of the specification. The foregoing and other features and advantages are apparent from the following detailed description taken in conjunction with the accompanying drawings in which:

FIG. 1 depicts a block diagram of a processing system for providing individualized risk assessments according to one or more embodiments of the present invention;

FIG. 2 depicts a cloud computing environment for providing individualized risk assessments according to one or more embodiments of the present invention;

FIG. 3 depicts a set of functional abstraction layers provided by the cloud computing environment of FIG. 2 according to one or more embodiments of the present invention;

FIG. 4 depicts a block diagram of a processing system for providing individualized risk assessments according to one or more embodiments of the present invention; and

FIG. 5 depicts a flow diagram of a method for providing individualized risk assessments according to one or more embodiments of the present invention.

### DETAILED DESCRIPTION

In accordance with one or more embodiments of the invention, methods, systems, and computer program products for user and location tailored travel-based risk assessments are provided. Various embodiments of the present invention are described herein with reference to the related drawings. Alternative embodiments can be devised without departing from the scope of this invention. References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

For the sake of brevity, conventional techniques related to computer processing systems and abstraction models may or may not be described in detail herein. Moreover, it is understood that the various tasks and process steps described herein can be incorporated into a more comprehensive procedure, process or system having additional steps or functionality not described in detail herein.

Turning now to a detailed description of the present invention, as previously noted herein, a huge volume of information is available for consideration prior to scheduling travel or deciding whether to engage in a particular activity. This information must be sufficiently collected, filtered, and reviewed to provide anyone a reasonable assessment of the risks involved when planning, for example, a trip or when choosing among possible excursions at a destination. The task can be overwhelming. In some situations, it is impractical for a person to adequately collect, filter, and review the vast amount of information the person, in an ideal situation having no time constraints, would wish to consider prior to making a decision. In other situations, travel, health, and safety concerns which could have resulted in an itinerary change are only identified at the last minute, or not at all. Thus, an automated travel advisor system and computer-implemented method for providing individualized risk assessments are desired.

One or more embodiments provide an automated travel advisor system, a computer-implemented method, and a computer product for providing individualized risk assessments. The individualized risk assessments are based in part on the personal characteristics of each user and the event characteristics of the user's current or anticipated location or activity. A subset of risks is obtained related to the user's personal characteristics and event characteristics. A notification, alert, or report is generated and provided to the user, a family member of the user, or another third party associated with the user. The report can include an organized list of individualized risks, an alternative suggestion to lower the individualized risks, and additional information associated with the individualized risks.

One or more embodiments of the invention include or yield various technical features, technical effects, and/or improvements to technology. Example embodiments of the invention provide an individualized risk assessment system configured to perform an automatic, unsupervised process to determine a user's individualized risks by receiving event data for the user, the event data including one or more event characteristics; responsive to receiving the event data for the user, obtaining a user profile including one or more personal characteristics of the user; responsive to receiving the user profile and the event data, obtaining, from at least one database containing risk elements, a subset of risk elements relevant to the event characteristics and the personal characteristics; and generating a report based on the subset of risk elements. These aspects of the invention constitute technical features that yield the technical effect of determining an individualized risk assessment via a process that avoids manually populating a user profile (e.g., using screen scraping or other data mining techniques) and the technical effect of using a machine learning technique to progressively improve data comparisons (e.g., comparing risk characteristics of a risk element to a reporting threshold and adjusting the threshold based on user events). As a result of these technical features and technical effects, an individualized risk assessment system in accordance with embodiments of the present invention represents an improvement to existing risk assessment techniques. It should be appreciated that the above examples of technical features, technical effects, and improvements to technology are merely illustrative embodiments of the invention and are not exhaustive.

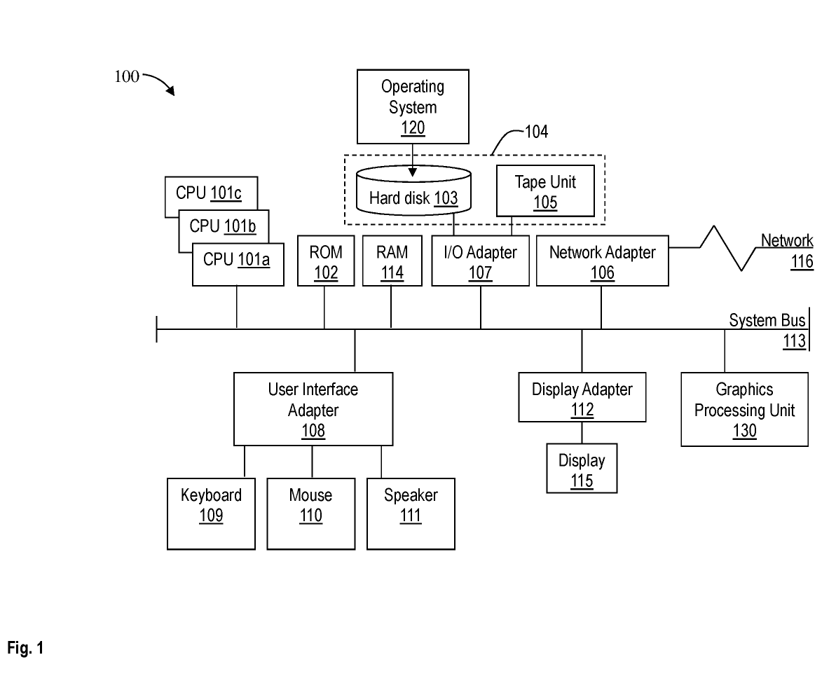

An automated travel advisor system, a computer-implemented method, and a computer product for providing user and location tailored travel-based risk assessments in accordance with one or more embodiments of the present invention are described in detail below by referring to the accompanying drawings in FIGS. 1-5.

FIG. 1 illustrates a block diagram of a processing system 100 for providing individualized risk assessments according to one or more embodiments. Processing system 100 can have one or more central processing units (processors) 101a, 101b, 101c, etc. (collectively or generically referred to as processor(s) 101 and/or as processing device(s) 101). In some embodiments, each processor 101 can include a reduced instruction set computer (RISC) microprocessor. Processors 101 are coupled to system memory (e.g., random access memory (RAM) 114) and various other components via a system bus 113. Read only memory (ROM) 102 is coupled to system bus 113 and can include a basic input/output system (BIOS), which controls certain basic functions of processing system 100.

Further illustrated are an input/output (I/O) adapter 107 and a network adapter 106 coupled to system bus 113. I/O adapter 107 can be a small computer system interface (SCSI) adapter that communicates with a hard disk 103, a tape unit 105, or any other similar component. I/O adapter 107, hard disk 103, and tape unit 105 are collectively referred to herein as mass storage 104. Operating system 120 for execution on processing system 100 can be stored in mass storage 104. A network adapter 106 interconnects system bus 113 with an outside network 116 enabling processing system 100 to communicate with other such systems.

A display (e.g., a display monitor) 115 is connected to system bus 113 by display adaptor 112, which can include a graphics adapter to improve the performance of graphics intensive applications and a video controller. In some embodiments, adapters 106, 107, and/or 112 can be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 can be interconnected to system bus 113 via user interface adapter 108, which can include, for example, a Super I/O chip integrating multiple device adapters into a single integrated circuit.

In some embodiments, processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured herein, processing system 100 includes processing capability in the form of processors 101, storage capability including system memory (e.g., RAM 114), and mass storage 104, input means such as keyboard 109 and mouse 110, and output capability including speaker 111 and display 115. In some aspects of the present invention, a portion of system memory (e.g., RAM 114) and mass storage 104 collectively store an operating system such as the AIX® operating system from IBM Corporation to coordinate the functions of the various components shown in processing system 100.

It is understood that the present invention is capable of being implemented in conjunction with any other type of computing environment now known or later developed. In some embodiments, the present invention can be implemented within a cloud computing architecture. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure including a network of interconnected nodes.

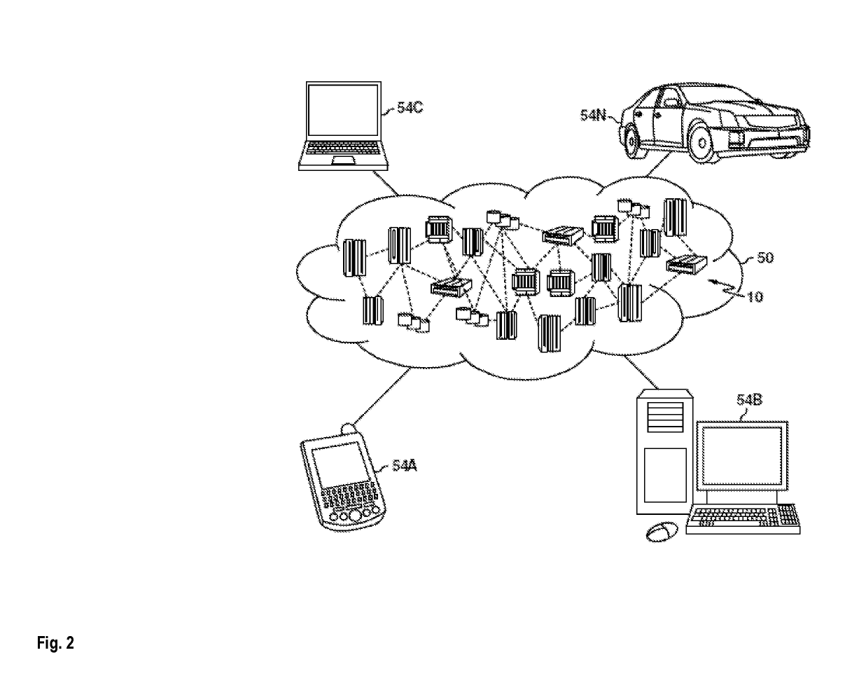

Referring now to FIG. 2, illustrative cloud computing environment 50 for providing individualized risk assessments is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Cloud computing nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

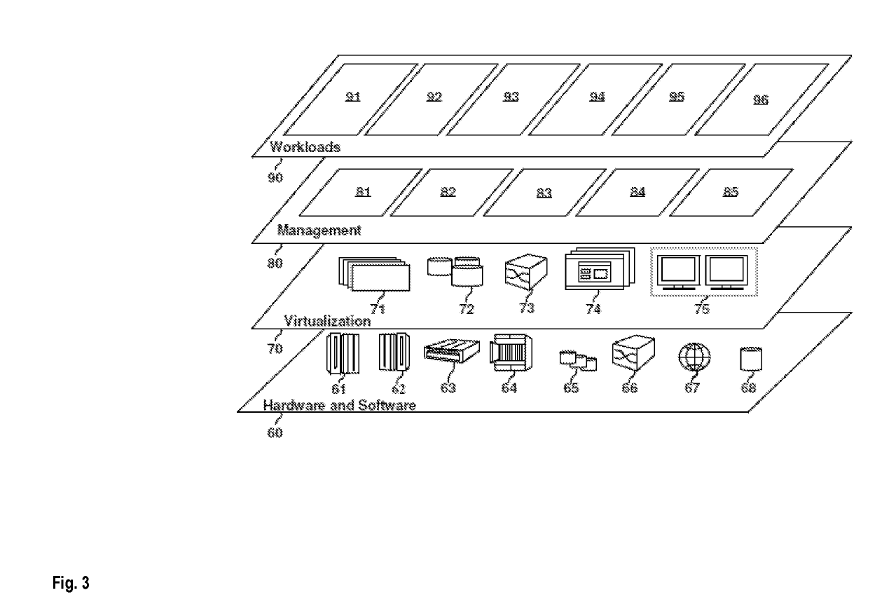

Referring now to FIG. 3, a set of functional abstraction layers provided by cloud computing environment 50 (FIG. 2) is shown. It is understood that the components, layers, and functions shown in FIG. 3 are intended to be illustrative only and that embodiments of the invention are not limited thereto. As illustrated, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In some embodiments, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

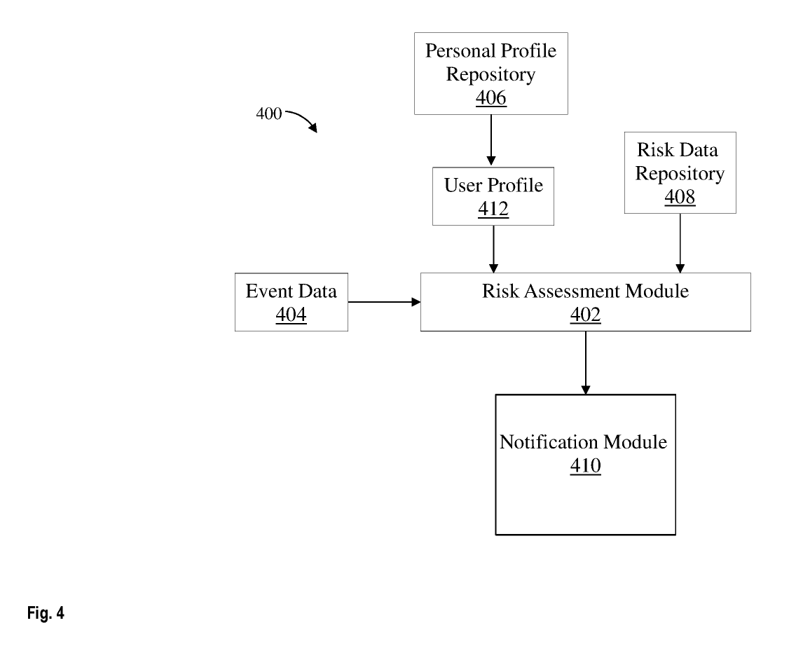

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and risk assessment container 96. In some embodiments, risk assessment container 96 provides the functionality of Risk Assessment Module 402 (as depicted in FIG. 4).

FIG. 4 illustrates a block diagram of a processing system 400 for providing individualized risk assessments according to one or more embodiments. The various components, modules, engines, etc., described regarding FIG. 4 can be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these. In some embodiments, the engine(s) described herein can be a combination of hardware and programming. The programming can be processor executable instructions stored on a tangible memory, and the hardware can include processor 101 (FIG. 1) for executing those instructions. Thus a system memory can store program instructions that when executed by processor 101 implement the engines described herein. Other engines can also be utilized to include other features and functionality described in other examples herein.

Processing system 400 can include processor 101, risk assessment module 402, event data 404, personal profile repository 406, risk data repository 408, and notification module 410. Personal profile repository 406 can include one or more profiles (e.g., user profile 412). Alternatively or additionally, the processing system 400 can include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

Risk assessment module 402 receives event data 404 for a person (e.g., a user of the processing system 400). The event data 404 includes one or more event characteristics. In some embodiments, the event characteristics include a current location or an anticipated location of the user. The location could be, for example, a city, a country, a monument, a hiking trail, a restaurant, a hospital, a lake, a beach, a mountain, a resort, a building, a theater, or GPS coordinates. The types of locations are not meant to be particularly limited. It is understood that event data 404 can include any location or anticipated location of the user.

In some embodiments, the event characteristics include a current activity or an anticipated activity of the user. The types of activities are not meant to be particularly limited, and can be, for example, travel to a particular destination, sleeping, eating, hiking, golfing, fishing, skiing, and running. It is understood that event data 404 can include any activity or anticipated activity of the user.

Risk assessment module 402 receives the user profile 412 including one or more personal characteristics of the user from the personal profile repository 406. In some embodiments, the risk assessment module 402 receives the user profile 412 responsive to receiving the event data 404. In some embodiments, the personal characteristics of the user include demographic data of the user, such as, for example, the user's age, gender, height, weight, home address, work address, phone number, marital status, next of kin, emergency contacts, or identity of owned pets. In some embodiments, the personal characteristics of the user include medical data, such as, for example, the user's known medical conditions or diagnoses (e.g., a history of chest pain, allergic to penicillin, diabetes, Alzheimer's), allergies, previous medical procedures (e.g., liver transplant, surgery to correct broken femur), or electronic health record (EHR) data. The personal characteristics can also include any medications or prescriptions of the user. In some embodiments, the personal characteristics of the user include hobbies or activities of interest to the user, such as, for example, fishing, skiing, or diving. In some embodiments, the hobbies or activities can be particular to a time of day, such as, for example, jogging in the morning or fishing in the evening. In some embodiments, the personal characteristics of the user include the current location of the user or an expected location of the user. An expected location can be determined, for example, with respect to the current time, contents of an email to or from the user, or an activity feed or comment associated with the user in a social networking account of the user. In some embodiments, the personal characteristics of the user include food or restaurant preferences, prohibited foods, or currently promoted foods. In some embodiments, the personal characteristics of the user include travel preferences, such as, for example, an aversion to flying or a preference for travel by train.

In some embodiments, a user profile 412 stored in the personal profile repository 406 is manually populated by a user or a third party associated with the user, such as, for example, a member of the user's family, a friend, a physician, a caregiver, or an authorized agent of the user. In other embodiments, the user profile 412 is passively populated by the processing system 400. In still other embodiments, the user profile 412 is populated by a combination of manual and passive techniques. In this manner, populating the user profile 412 does not require the user to manually input every possibly relevant personal characteristic. Any known technique for passively populating the user profile 412 can be used. In some embodiments, passively populated data can be manually modified or deleted by the user or a third party associated with the user.

In some embodiments, the processing system 400 accesses a social networking profile of the user, using, for example, login information of the user in combination with screen scraping or other data mining techniques. The processing system 400 can modify the personal characteristics of the user profile 412 based on a number of associated “likes” or comments of the user. For example, the processing system 400 can automatically include “swimming” in the user profile 412 when topics including the term swimming are often liked by the user. In some embodiments, a threshold number or percentage of likes are required before the processing system 400 will add a personal characteristic to the user profile 412. In some embodiments, the processing system 400 can modify the personal characteristics of the user profile 412 based on a club membership or an activity feed of the user. For example, the processing system 400 can automatically include “hiking” in the user profile 412 when hiking appears repeatedly in the user's activity feed or when the user is a member of a hiking club.

In a similar manner, the processing system 400 can access and data mine an email account of the user. For example, the processing system 400 can add “boating” to the user profile 412 based on an emailed receipt of boating equipment. In some embodiments, the processing system 400 can add personal characteristics to the user profile 412 which are frequently mentioned in emails sent to or from the user.

Risk assessment module 402 obtains a subset of risk elements relevant to the event characteristics and the personal characteristics from the risk data repository 408. In some embodiments, the risk assessment module 402 receives the risk elements responsive to receiving the user profile 412 and the event data 404. Risk data repository 408 can be a single database or a plurality of databases. Each risk element can include one or more risk characteristics, such as, for example, risk types, personal characteristics shared by people subject to the risk element, a risk location, and risk severity scores. A risk type could be, for example, a risk of robbery or a specific injury. A risk location could be, for example, a particular hiking trail or GPS location. A risk severity score could be, for example, a numerical score, such as a score of 34 in a severity range of 1 to 100, or a categorical score, such as a risk of death or mild pain. For example, a risk element can include a risk of breaking a leg associated with “joggers” or “hikers” or “bikers” at a particular park, or on a particular trail at the park. The risk severity associated with breaking a leg could be 85 out of 100 or “severe”.

In some embodiments, relevant risk elements are obtained by comparing the risk characteristics of each risk element to the event characteristics of the event data 404 and to the personal characteristics of the user profile 412. For example, the risk assessment module 402 can obtain all risk elements which indicate a personal characteristic of people subject to each risk element matching a personal characteristic of the user. In another example, risk elements associated with “hiking” at “Green Acre Park” are obtained when an event characteristic of the event data 404 includes, e.g., a GPS location of Green Acre Park, and a personal characteristic of the user includes, e.g., hiking.

In this manner, the risk elements obtained by the risk assessment module 402 are individualized to the user (i.e., a different subset of risk elements can be obtained for different users having an identical event characteristic). In some embodiments, a different subset of risk elements can be obtained for different users at the exact same location (e.g., Green Acre Park) or for the exact same activity (e.g., travel to a particular city or country) because each user will have different personal characteristics. For instance, risk elements associated with “swimming” at “Green Acre Park” are obtained for a second user located at Green Acre Park having the “swimming” personal characteristic.

Similarly, the risk assessment module 402 will obtain a different subset of risks for event characteristics identifying the same overseas city as a travel destination for different users. For example, the risk assessment module 402 can obtain “smog alert” risk elements associated with the overseas city for a first user having an “asthma” personal characteristic, “air travel advisory” risk elements associated with the overseas city reachable only via flight for a second user having an “adverse to air travel” travel preference, and “local SARS outbreak” risk elements for a third user having an “autoimmune deficiency” medical based personal characteristic.

In some embodiments, the risk assessment module 402 obtains only those risk elements which satisfy a relevancy threshold for at least one event characteristic or personal characteristic. The threshold for each risk element could be manually set or automatically determined by the processing system 400, e.g., by comparison to other risk element thresholds or by a machine learning technique. Any known a neural network or machine learning technique can be used to automatically determine the risk element thresholds. In some embodiments, the risk assessment module 402 adaptively adjusts risk element thresholds based on event data 404 or personal characteristics of one or more users. For example, the risk assessment module 402 can increase a threshold (i.e., decrease the likelihood of obtaining a particular risk element) when users systematically ignore that risk element (e.g., indicating that users are not persuaded that the risk element is particularly relevant to a particular event characteristic or personal characteristic).

In some embodiments, risk assessment module 402 calculates an event risk score based on the risk severity scores of the subset of risk elements. The event risk score can be, for example, a weighted average, mean, median, maximum, minimum, or other function of the risk severity scores. In some embodiments, only risk severity scores above or below a preselected value or threshold are included in the event risk score. The value or threshold can be manually set or automatically selected by the processing system 400, based on, for example, a comparison of the values or thresholds for other risk elements or by a machine learning technique. Any known a neural network or machine learning technique can be used to automatically select the value or threshold.

In some embodiments, notification module 410 generates a report, alert, alarm, or other type of notification. The notification can include, for example, the subset of risk elements and the event risk score. In some embodiments, the notification module 410 identifies one or more risk management strategies to lower the event risk score. For example, the notification module 410 can suggest an alternative activity, destination, location, food selection, or method of transportation. In some embodiments, the report is organized by the risk severity score of each risk element or by the risk management strategies which provide the greatest reduction in the event risk score.

In some embodiments, the report is only generated when an individual risk severity score or the event risk score is greater than or less than a predetermined value or threshold. In this manner, the user is only altered to sufficiently dangerous or relevant risks. The value or threshold can be manually set or automatically selected by the processing system 400, based on, for example, a comparison of the values or thresholds for other risk elements or by a machine learning technique. Any known a neural network or machine learning technique can be used to automatically select the value or threshold.

In some embodiments, the report includes risk elements for risk elements having an extremely high risk severity score (e.g., a numerical score greater than 94 out of 100 or an indicated risk of death) even when the risk characteristics of those risk elements do not match the received event characteristics or personal characteristics. For example, even if user profile 412 does not indicate a personal characteristic for “swimming”, an alert will be generated to avoid swimming when the user enters a swimming location that is near a reported chemical spill.

In some embodiments, the report identifies one or more suggestions relevant to one or more event characteristic or personal characteristic. For example, if risk assessment module 402 receives an event characteristic of event data 404 including the location of a particular restaurant and a user profile 412 indicating a “gluten allergy” personal characteristic the notification module 410 can generate a report suggesting a particular gluten-free menu item. In another example, if risk assessment module 402 receives an event characteristic of event data 404 including the location of a particular park and a user profile 412 indicating a “cat and dog allergy” the notification module 410 can recommend avoiding a particular trial in the park having a high rate of stray dogs and cats. In a further example, if risk assessment module 402 receives an event characteristic of event data 404 including the location of a particular park having several available trails and a user profile 412 indicating a “heart condition” or a recent (e.g., within the prior 6 months, or past year) diagnosis of a heart attack, the notification module 410 can recommend the easiest trial based on obtained risk elements (e.g., a trail having a lowest injury rate).

In some embodiments, a link is included in the report. The link can direct the user to additional information relevant to an event characteristic, a personal characteristic, or a risk characteristic. Any known method for providing the link can be used. In some embodiments, the link is a hyperlink to a website or portal including the additional information. In other embodiments, selecting the link opens a popup in a user interface of a device of the user. For example, a user having a “hiking” personal characteristic can receive a report from notification module 410 suggesting a particular trail at the current location of the user (e.g., a particular park or GPS coordinate indicated by the event data 404) based on risk elements obtained by the risk assessment module 402. A link is provided to the user that directs the user to recent police report data for the other trails, indicating that the other trails are not currently safe.

In some embodiments, the notification module 410 can request additional information from the user. For example, possible travel methods, travel times, planned activities, or other information relevant to event data 404 not currently available in the user profile 412 can be requested. In this manner, the quality of the risk elements obtained by the risk assessment module 402 is improved.

In some embodiments, notification module 410 provides the report to a family member, a designated person, a doctor, a caregiver, or another third party associated with the user. For example, notification module 410 can send an alert to a patient' s caregiver or spouse when the patient, having a strict dietary restriction, enters the location of a prohibited restaurant (i.e., as indicated by the event data 404). In another example, notification module 410 can send an alert to a user's primary caregiver or spouse when the user enters the location of a hospital or other treatment center (e.g., indicating that the user is in distress or having a medical emergency).

Travel Advisor Embodiment

In some embodiments, risk assessment module 402 serves as a travel advisor and is implemented as a client-thin smartphone or computer portal. The portal provides access to the risk assessment module 402, which can be remotely located (e.g., in a cloud architecture) in accordance with one or more embodiments. A user accesses the portal using, for example, login credentials. The portal includes the user profile 412, populated in accordance with one or more embodiments. In this manner, a user planning a trip can log into the portal and enter the event data 404 (e.g., a potential travel location) into a query system of the portal. The risk assessment module 402 can obtain individualized risk elements and can generate a report, including recommendations, in accordance with one or more embodiments.

For example, Ashley, planning a trip to Australia, logs into the portal and enters “Australia” into the query system. The risk assessment module 402 obtains risk elements associated with Australia relevant to various personal characteristics of Ashley, such as, for example, “scuba diving” and “equestrian” related risks. The risk assessment module 402 obtains safety statistics for one or more horseback riding trails as well as weather reports for one or more scuba diving locations. Based on these obtained risk elements, a notification module 410 of the risk assessment module 402 generates a report recommending that Ashley visit a particular area of Australia having a large number of safe horseback riding trails as well as a close proximity to a scuba diving location with anticipated clear weather. The report also alerts Ashley to a food poisoning outbreak in the area and recommends Ashley avoid particular restaurants in close proximity to a hospital having an unusually high number of food poisoning related admissions. The report also recommends that Ashley avoids a particular airline due to an abnormally high lost plane occurrence.

Smart Device Embodiment

In some embodiments, risk assessment module 402 is implemented as software or hardware in a smart device, such as, for example, a smartphone or smart watch. A user accesses the risk assessment module 402 using, for example, an app installed in the smart device. The app includes the user profile 412, populated in accordance with one or more embodiments. In some embodiments, the smart device includes a GPS. In this manner, a location of the user is periodically or continuously updated as event data 404. Based on the event data 404, the risk assessment module 402 can periodically or continuously generate a report, including recommendations, in accordance with one or more embodiments.

For example, Andrew, wearing a smart watch in accordance with one or more embodiments, enters a restaurant. The risk assessment module 402 is updated with event data 404 including the location of the restaurant. In response, the notification module 410 of the risk assessment module 402 provides a list of recommended menu items to Andrew, taking into account his gluten allergy and his high cholesterol. A link is provided for each menu item, which directs Andrew to a list of ingredients and nutritional information. An alternative nearby restaurant having a higher percentage of low cholesterol foods is recommended. Later on that day, Andrew approaches a hotel. The risk assessment module 402 is updated with event data 404 including the location of the hotel. In response, the notification module 410 of the risk assessment module 402 provides a warning to Andrew that the hotel has recent food safety citations and that the surrounding area has a relatively high crime rate. An alternative hotel is suggested.

Activity Monitor Embodiment

In some embodiments, risk assessment module 402 is implemented as a health monitor with third party reporting functionality. For example, a patient having a strict dietary restriction can receive an alert from notification module 410 when the patient approaches a restaurant which does not have any unrestricted menu items. If the patient remains at the location of the restaurant for a sufficient period of time a report can be generated and provided to the patient's caregiver. In some embodiments, risk assessment module 402 compares event data 404 to an expected activity and notification module 410 provides an alert when the event data 404 does not indicate that the expected activity is occurring. In this manner, adherence to a medical regimen can be monitored. For example, a patient is prescribed a thirty-minute exercise routine which is typically completed between 3 and 4 pm. An alert is generated by the notification module 410 when the event data 404 indicates that the user is sleeping (e.g., the patient has not moved from the bedroom in 5 hours) or engaging in another activity (e.g., the patient is instead at a restaurant). In some embodiments, the third party report is only generated when the risk is above a certain threshold. In this manner, minor risks are ignored and the third party is only alerted of the most important risks. In some embodiments the third party report is only generated for pre-determined events or event characteristics (e.g., a prohibited location or a prohibited activity). In this manner, the third party can customize the alert parameters based on the individual needs of the user (i.e., the patient).

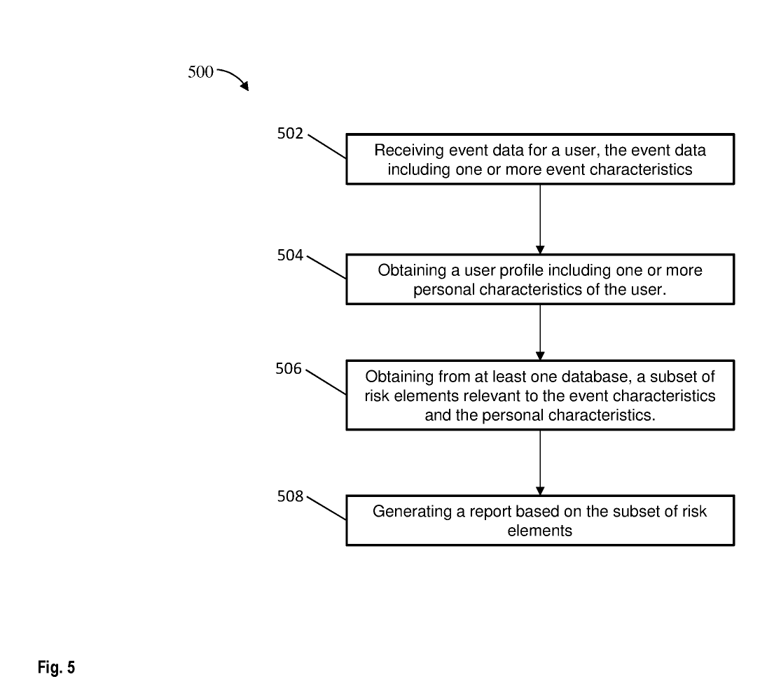

FIG. 5 illustrates a flow diagram of a method 500 for providing an individualized risk assessment according to one or more embodiments. As shown at block 502, event data 404 for a user is received (e.g., by the risk assessment module 402), according to one or more embodiments. The event data includes one or more event characteristics.

As shown at block 504, the risk assessment module 402 obtains a user profile 412 of the user. The user profile 412 includes one or more personal characteristics according to one or more embodiments. In some embodiments, the risk assessment module 402 obtains the user profile 412 in response to receiving the event data 404 for the user.

The risk assessment module 402, as shown at block 506, obtains from the risk data repository 408 a subset of risk elements relevant to the event characteristics and the personal characteristics, according to one or more embodiments. In some embodiments, risk assessment module 402 obtains the subset of risk elements in response to receiving the event data 404 and the user profile 412.

As shown at block 508, notification module 410 of the risk assessment module 402 generates a report, according to one or more embodiments. The report can be organized by, for example, risk severity, risk type, a manual setting, or automatically, according to one or more embodiments. The report is provided to the user, a third party associated with the user, or both, according to one or more embodiments. The report can include, for example, a recommended activity or a warning to avoid a particular activity.

Additional processes also can be included, and it should be understood that the processes depicted in FIG. 5 represent illustrations, and that other processes can be added or existing processes can be removed, modified, or rearranged without departing from the scope and spirit of the present invention.

The present techniques can be implemented as a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry and to perform aspects of the present invention.

Aspects of the present invention are described herein with reference to flowchart illustrations and/or block diagrams of methods, apparatus (systems), and computer program products according to aspects of the present invention. It is understood that each block of the flowchart illustrations and/or block diagrams, and combinations of blocks in the flowchart illustrations and/or block diagrams, can be implemented by computer readable program instructions.

These computer readable program instructions can be provided to a processor of a special purpose computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the present invention. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It is understood that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments described herein.

1. A computer-implemented method for providing individualized risk assessments, the method comprising:
receiving, by a processor, event data for a user, the event data comprising one or more event characteristics;
obtaining, by the processor, a user profile comprising one or more personal characteristics of the user, the personal characteristics comprising hobbies and activities of interest;
obtaining, by the processor from at least one database containing risk elements, a subset of risk elements such that each risk element satisfies a relevancy threshold with respect to both the event characteristics and the hobbies and activities of interest of the user, each risk element comprising a risk severity score;
calculating an event risk score based on the risk severity scores of the subset of risk elements; and
generating, by the processor, a report based on the subset of risk elements, the report comprising a suggested user action to lower the event risk score.

2. The computer-implemented method of claim 1, wherein each risk element comprises a risk type and one or more personal characteristics of people subject to the risk element.

3. (canceled)

4. The computer-implemented method of claim 2, further comprising identifying one or more risk management strategies to lower the event risk score.

5. The computer-implemented method of claim 1, wherein the event characteristics comprise a location or an activity of the user.

6. The computer-implemented method of claim 1, wherein the personal characteristics comprise demographic data, medical data, prescription data, hobbies, locations, food preferences, or travel preferences of the user.

7. (canceled)

8. The computer-implemented method of claim 2, further comprising providing the report to the user.

9. The computer-implemented method of claim 8, wherein the report is organized by the risk severity score of each risk element.

10. The computer-implemented method of claim 8, wherein the report identifies one or more suggestions relevant to one or more event characteristic or personal characteristic.

11. The computer-implemented method of claim 8, further comprising providing a link in the report to additional information relevant to an event characteristic or a personal characteristic.

12. The computer-implemented method of claim 1, further comprising providing the report to a family member, a designated person, a doctor, a caregiver, or another third party associated with the user.

13. A system for providing individualized risk assessments, the system comprising:
a memory having computer readable instructions; and
a processing device for executing the computer readable instructions, the computer readable instructions that cause the processing device to:
receive event data for a user, the event data comprising one or more event characteristics;
obtain a user profile comprising one or more personal characteristics of the user, the personal characteristics comprising hobbies and activities of interest;
obtain a subset of risk elements such that each risk element satisfies a relevancy threshold with respect to both the event characteristics and the hobbies and activities of interest of the user; and
generate a report based on the subset of risk elements.

14. The system of claim 13, wherein each risk element comprises a risk type, one or more personal characteristics of people subject to the risk element, and a risk severity score.

15. The system of claim 14, further comprising calculating an event risk score based on the risk severity scores of the subset of risk elements.

16. The system of claim 15, further comprising identifying one or more risk management strategies to lower the event risk score.

17. A computer program product for providing individualized risk assessments, the computer program product comprising:
a computer readable storage medium having program instructions embodied therewith, the program instructions executable by a processing device to cause the processing device to perform a method comprising:
receiving event data for a user, the event data comprising one or more event characteristics;
obtaining a user profile comprising one or more personal characteristics of the user, the personal characteristics comprising hobbies and activities of interest;
obtaining a subset of risk elements such that each risk element satisfies a relevancy threshold with respect to both the event characteristics and the hobbies and activities of interest of the user; and
generating a report based on the subset of risk elements.

18. The computer program product of claim 17, wherein the personal characteristics comprise demographic data, medical data, prescription data, hobbies, locations, food preferences, or travel preferences of the user; and wherein the event characteristics comprise a location or an activity of the user.

19. The computer program product of claim 17, further comprising providing the report to the user, a family member of the user, a designated person of the user, a doctor of the user, or a caregiver of the user.

20. The computer program product of claim 19, wherein the report identifies one or more suggestions relevant to one or more event characteristic or personal characteristic; and wherein the report includes a link to additional information relevant to an event characteristic or a personal characteristic.
